(19) United States
(12) Patent Application Publication
(10) Pub. No.: US 2012/0050049 A1
(43) Pub. Date: Mar. 1, 2012

(54) Safety Alarm and Method

(76) Inventor: Victor Manuel Quinones Caballero, San Juan, PR (US)

(21) Appl. No.: 12/862,670

(22) Filed: Aug. 24, 2010

(51) Int. Cl. G08B 23/00

(52) U.S. Cl. 340/573.6

(57) ABSTRACT

A water safety alarm apparatus and method to detect the presence or absence of persons while taking baths or showers in bathing units or structures. The alarm and method are also for detecting the presence or absence of adults or personnel assisting the persons in the bathing units or structures.

### STATEMENT REGARDING FEDERALLY SPONSORED RESEARCH AND DEVELOPMENT

N/A

### RELATED APPLICATIONS

N/A

### BACKGROUND

1. Field of the Invention

This invention relates to a safety alarm and method which operates an alarm or alert. The safety alarm detects if a child or a person is alone or in danger while taking a bath, sounding an alarm and controlling the water.

2. Discussion of the Background

There are various scenarios where a baby, a child, a handicapped person, or a senior citizen might be in danger while taking a bath or a shower. These dangers vary depending on the age and capacity of the child or person to bathe by themselves and the bathing structure in use. Often, children, as well as handicapped persons and senior citizens, bathe or shower with the help of an adult such as a family member or a health care professional. Of course, babies should always be bathed by an adult.

Babies, children, handicapped persons, and senior citizens are just examples of “high risk persons”, people who are at high risk of suffering serious injuries, slips, drowning or death while bathing or taking showers. Because the bathing structure affects the risk and dangers involved with the bathing of a high risk person, one has to consider whether the person is bathing or taking a shower in a tub, a jacuzzi, another type of enclosed structure capable of holding or accumulating water, or if the structure is open and allows water to drain away without accumulating said water. Bathing structures and bathing units which allow water to accumulate increase the risk of a high risk person to fall below the water level accumulated and therefore drown and possibly suffer brain damage or die. On the other hand, bathing structures and bathing units which do not accumulate water will still have surfaces on which high risk persons may stand on, causing possible slips and injuries. Therefore, regardless of the amount or type of risk involved with regard to the bathing structure and the high risk person in such bathing structure, it is important to have an adult or healthcare professional at all times present and aware of the condition of the high risk person that is taking a bath.

Alarms, detectors and monitors generally detect the presence of persons, or may detect or control flow of water. However, these devices do not detect the presence of a high risk person in a bathing structure or alert an adult or a healthcare provider if a high risk person is alone while bathing.

### SUMMARY

I invented an alarm that lowers the risk of physical harm of persons in bathing units. An alarm having features of the present invention comprises a person detecting device configured to detect the presence of a person inside a bathing unit, one or more alerting devices for alerting the occurrence of high risk situations, and a controller circuit connected to the person detecting device and to the alerting devices. The controller circuit responds to detection signals from the person detecting device and activates the alerting devices in case that a high risk situation is detected.

Optionally, the invention may also comprise a water detecting device for detecting the presence of water in the bathing unit, a water control system for controlling the flow and presence of water in the bathing unit, or both. The water detecting device and the water control system would be connected to the controller circuit. With respect to the water detecting device, the controller circuit would be responsive to detection signals from the water detecting device for activating the alerting devices in case that a high risk situation is detected. As to the water control system, the controller circuit would be configured to automatically send control signals to the water control system to control the flow of water into the bathing unit in case that a high risk situation is detected.

As to the alerting devices, these may comprise speakers for sounding alarms, light indicators such as light bulbs or light emitting diodes which may visibly alert the location where a high risk situation is detected, mobile devices such as cell phones and beeper, monitors, panels, computers.

Another optional feature is to have a communication system included with or connected to the controller circuit, enabling wireless transmission to and from the controller circuit with all other devices and systems through the communication system. Some or all devices would be connected, send to or receive signals from, wired or wirelessly or otherwise, to the controller circuit through the communication system. Of course, if the communication system is integrated into the controller circuit, then one circuit does it all. Also, the controller circuit could be integrated with any of the other devices, or stand alone by itself. An example of integration is having any of the sensors or detectors include the controller circuit in its package or its own circuitry.

Yet another optional feature is to have two person detecting devices. The first person detecting device would be configured to detect the presence of a person inside a bathing unit, while the second detecting device detects the presence of another person, which may be a healthcare professional, next to the bathing unit.

The present invention provides a safety alarm and method for reducing the risk of persons and high risk persons in bathing units. As such, the sensors and detectors automatically communicate with the controllers, thereby stopping water from flowing into the bathing unit and sounding alerts and triggering alarms and alerts in case that a high risk situation is detected.

The invention itself, both as to its configuration and its mode of operation and its features, aspects, and advantages, will be best understood, and additional objects and advantages thereof will become apparent, by the following detailed description of a preferred embodiment taken in conjunction with the accompanying drawings and appended claims.

The applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constitute part of the specifications and illustrate the preferred embodiments of the invention.

FIG. 1 is a perspective view of the invention showing the front face.

FIG. 2 is a perspective view of the invention showing the back.

FIG. 3 is a perspective view of an alternative embodiment of the invention.

FIG. 4 is a view of an alternative embodiment of the invention placed at a bathing unit.

FIG. 5 is a view of another alternative embodiment of the invention placed at a bathing unit.

FIG. 6 is a view of an alternative embodiment of the invention with a water detecting device.

FIG. 7.A is a view of an alternative embodiment of the invention placed at a bathing unit with an expanded view behind one of the walls of a bath tub in the bathing unit.

FIG. 7.B is view an alternative embodiment for the water detecting device.

FIG. 8 is a view of the connectivity between the elements of the invention.

FIG. 9 is a view of the connectivity between the elements of an alternative embodiment of the invention, showing a communication circuit.

FIG. 10 is a side view of the invention placed at a bathing unit, showing the connection and placement of a water control system at a shower head.

FIG. 11.A is a top view of the invention placed at a bathing unit with a shower, with alerting devices placed outside the bathing unit and a person assisting the high risk person in the bathing unit.

FIG. 11.B is a top view of the invention placed at a bathing unit with a shower, with alerting devices placed outside the bathing unit and being activated wirelessly, with a person being alerted to assist the high risk person in the bathing unit.

FIG. 12 is a view of an alternative embodiment of the invention placed at a bathing unit with alerting devices inside and outside the bathing structure.

FIG. 13.A is a flowchart of the process for triggering the alerting devices.

FIG. 13.B is a flowchart of the process for triggering the alerting devices and stopping the water flow.

FIG. 13.C is a flowchart of an alternative process for triggering the alerting devices.

FIG. 13.D is a flowchart of an alternative process for triggering the alerting devices and stopping the water flow.

FIG. 13.E is a flowchart of a process with steps running in parallel with each other for triggering the alerting devices.

FIG. 13.F is a flowchart of a process with steps running in parallel with each other for triggering the alerting devices and stopping the water flow.

FIG. 13.G is a flowchart of a process for triggering the stop of water flow.

FIG. 13.H is a flowchart of an alternative process for triggering the stop of water flow.

FIG. 13.I is a flowchart of a process for triggering the stop of water flow with detection of a second person.

FIG. 13.J is a flowchart of a process for triggering the stop of water flow and alerting devices with detection of a second person.

### DESCRIPTION

The present invention relates to an apparatus and method for detecting if a high risk person is alone or at risk in a bathing unit.

“Connections”, for purposes of this specification and the claims, is not limited to electrical connections such as wires. “Connections” comprises wireless connections, or any other type of connection that achieves the transmission of a signal. “Alerting devices”, for purposes of this specification and the claims, are any devices or mechanisms of alarming or alerting individuals or persons, such as alarms, speakers, sirens, lights, beepers and vibrators, computers with alarm terminals, and similar devices. “Bathing unit”, for purposes of this specification and the claims, is any shower, bath tub, or place where a person, baby, or child may be bathing, such as a jacuzzi or a pool. A “high risk situation” comprises situations in which persons, and specially high risk persons, are at improper or unnecessary risk of bodily harm while in bathing units or while bathing. Examples of high risk situations are when high risk persons are by themselves in bathing units or bathing structures, when a person falls or slips in the bathing structure, when the sensors or detectors of the present invention do not detect a person in the bathing unit, or those scenarios or situations that are capable of being detected by the present invention.

FIG. 1 shows a alarm 1, which has a first person detecting device 100, a second person detecting device 101, and an alerting device 102. Alarm 1 also has a water flow detector 103. All the internal components and electronics of the alarm 1 are enclosed by a waterproof enclosure 104.

The first person detecting device 100 and second person detecting device 101 may be acoustic sensors, which detect objects placed within their range and scope of detection by sending acoustic waves which hit the object within their range and scope and send back to the acoustic sensor a reflected wave. Another implementation involves using photo-sensors, which sense changes in lighting around the photo-sensors, such as those caused by the movement or proximity of objects. Yet another implementation would be to use electromagnetic sensors. One way of using electromagnetic sensors is to send an electromagnetic wave which would bounce off from a person standing within the range and scope of the person detecting device. The reflected electromagnetic wave would be detected by the sensor, indicating that a person in front and detected by the sensor. Of course, the objects which would provoke detection for person detecting devices are actual persons within the range and scope of the person detecting devices. Therefore, depending on the position of the person detecting devices relative to the bathing unit and where people might be standing, it would be convenient to orient or direct the sensors or person detecting devices in directions that result in the correct detection of persons in front of the corresponding person detecting device. In FIG. 1, person detecting device 100 is oriented downward to detect a child below the level of alarm 1 in a bathing unit.

Water flow detector 103 may be implemented with a microphone and corresponding electronic circuitry. Such a microphone would be able to listen, or filter, the particular patterns and sounds of water flow and water splashes, such that the water flow detector is able to detect and indicate whenever there is water flowing into the bathing unit. Another way to implement water flow detector 103 is to include it or embed it within water controller 601. There, water flow detector 103 could be a mechanical detector, which detects flow through the valves or pipes of water controller 301. Also, water flow detector 103 could operate mechanically at the pipes of the bathing unit, without the presence of a water controller 301. However, the microphone implementation is preferred as a cheaper and effective implementation.

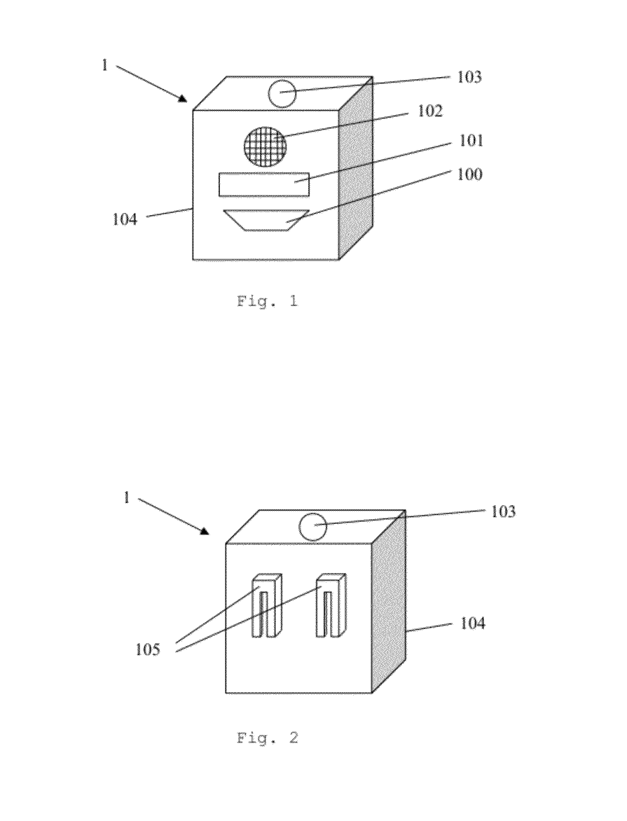

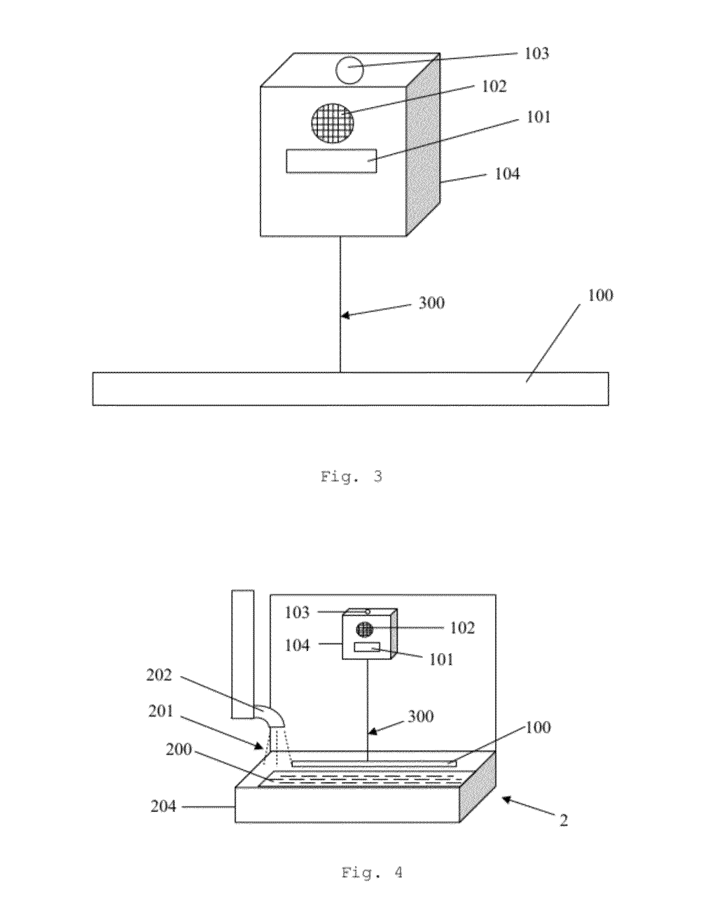

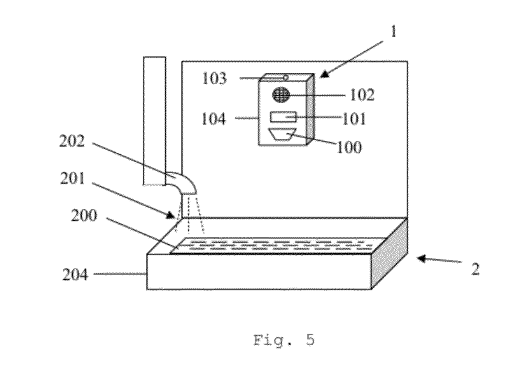

FIG. 2 shows the back of alarm 1, making visible the attachment mechanism 105, which may be used to attach alarm 1 to a wall or other structure. Although there are many ways that alarm 1 may be attached to any particular place, FIG. 2 particularly shows a set of two hooks.

FIG. 3 shows another implementation of the invention, where person detecting device 100 is not found within waterproof housing 104. FIG. 3 also shows electric connection 300, which connects person detecting device 100 to the controller circuit 600. Controller circuit 600 is inside waterproof enclosure 104.

FIG. 4 shows the invention as in FIG. 3, but placed in bathing unit 2. Bath tub 204 of bathing unit 2 is filled with water 200. Flowing water 201 is coming out of faucet 202, filling the bath tub 2 with more water. In this scenario, without people being detected by the invention as implemented, the invention could be programmed to sound the alarm to alert that water is going to waste, as there is nobody in the bathing unit using it.

FIG. 5 shows an the alternative implementation of alarm 1 placed in bathing unit 2.

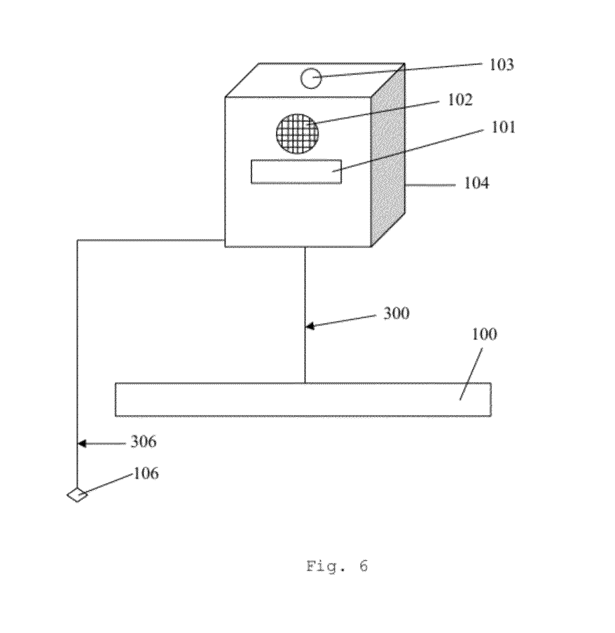

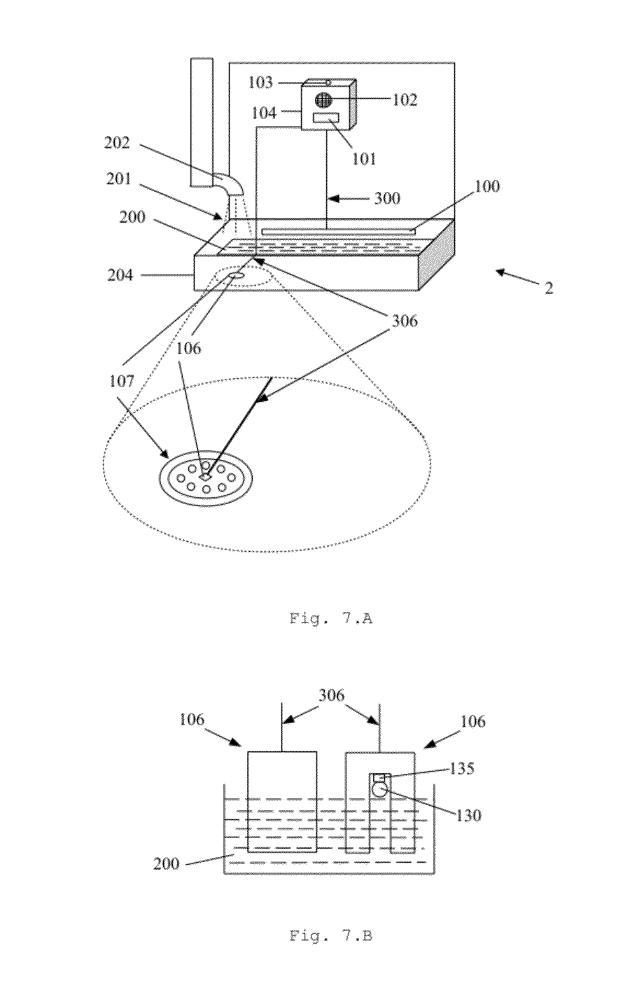

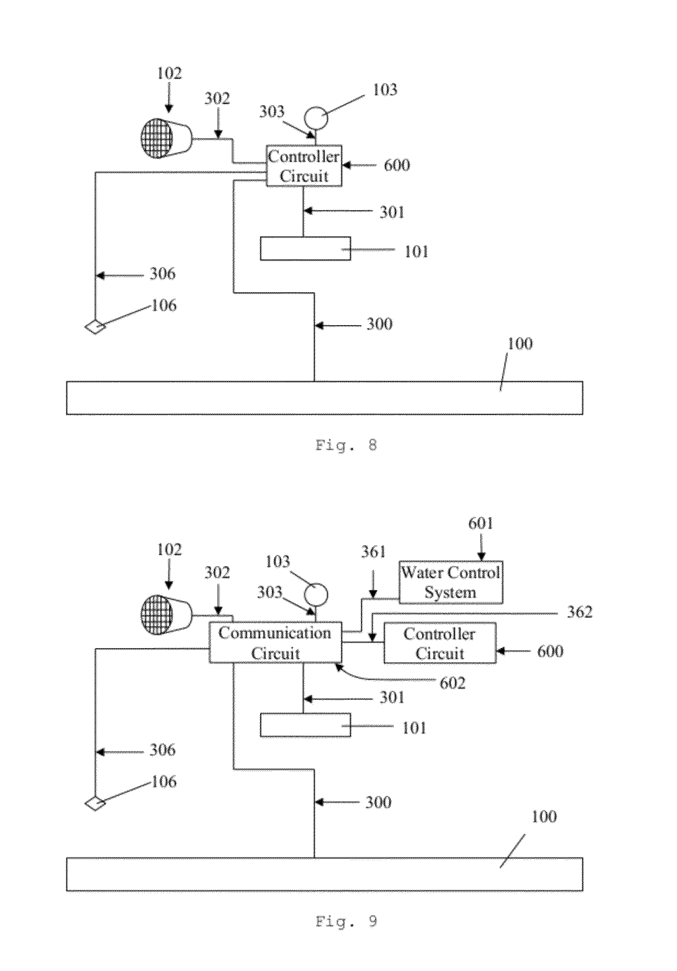

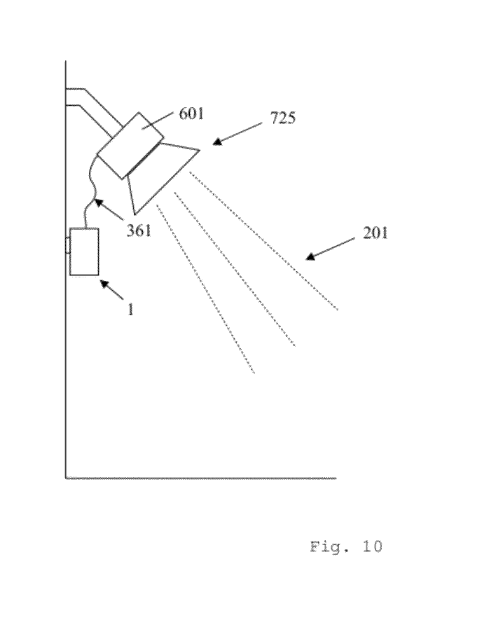

FIG. 6 shows the same implementation of the invention as in FIG. 3, but a water detecting device 106 has been added. FIG. 7.A shows and expanded or x-ray view behind the walls of bath tub 204, below the water 200, where water detecting device 106 can be seen placed by drain 107. Water detecting device 106 connects to the rest of the alarm's components through connection 306. With water detecting device 106 in place, even if the sound of water is not detected, or if there is no water flowing into a bathing unit, the alarm may still go of for a risk situation if there is water detected in a bathing unit and a person is detected to be alone in the bathing unit.

A simple way of implementing water detecting device 106 is to place a water detector or water resistant conductivity sensor. Bath water is likely to be ionized, meaning that it can close a circuit as a conductor. An electrically non-threatening circuit may be closed at water detecting device 106, by the water ionizing and becoming the conductor or link that closes the circuit, making it possible to detect the presence of water in a bathing unit. A particular way of doing this is having the surface of water detecting device 106 expose two separate leads or wires or conducting pads, which if connected would close the circuit. If the surface of water detecting device 106 is immersed in water, the circuit will close, signaling the presence of water in the bathing unit. Other simple mechanism of detecting the presence of water will be apparent to those skilled in the art.

Another way of implementing water detector 106 is show in FIG. 7.B. There, water detector 106 is show twice, as it would be implemented and with a cross section view showing the hollow inside and a floating ball 130. When water 200 fills up the hollow space inside mechanical sensor 106, floating ball 130 floats up and pushes against trigger 135. Trigger 135 could be a push button that when pushed activates or sends a signal through connection 306. Trigger 135 could be completely mechanical or work as a relay, connecting two points inside sensor 106, thereby closing a circuit and triggering a signal of water presence. Trigger 135 could also just be a device at least two leads or plates facing down to the direction of the floating ball 130. Floating ball 130 would be a conductor, which would float to trigger 135 and touch the wires or plates, closing a circuit which signals detection of water through connection 306. Floating element 130 could be of any shape other than spherical.

FIGS. 8 and 9 show the connections between the different active components and elements of the alarm, including additional optional elements such as the water control system 601 and the communications circuit 602 which connect to the controller circuit 600. FIG. 8 show various elements connecting directly to the main control system 600. As explained before “connections” may be a physical, mechanical or electrical connection as well as a wireless connection, so that connections 300, 301, 302, 303, 306, 361, and 362 might be any type of connection. So, if controller circuit 600 has an embedded wireless communication system, it may conduct wireless communications with other devices. FIG. 9 explicitly shows a communication system 602, and all devices connecting to the communication system 602. The communication circuit 602 routes the information and signals between main controller 600 and the devices, controllers and sensors 100, 101, 102, 103, 106, and 601.

FIG. 10 shows alarm 1 with connection 361 to control water controlling device 601. Water controlling device 601 is placed behind shower head 725, which allows for water 201 to fall out from the showerhead. Water controller 601 would be able to stop water 201 from coming out of shower head 725 if triggered or operated by alarm 1 to do so, particularly if a high risk situation were detected. Water controlling device 601 might operate with a controllable mechanical valve, which opens or closes, allowing or stopping water from flowing through the valve. Of course, a more expensive approach would be to place controlling device 601 inside the pipes or walls of the bathing unit, which might be appropriate if the high risk persons are mental patients that may attack or damage the water controller 601.

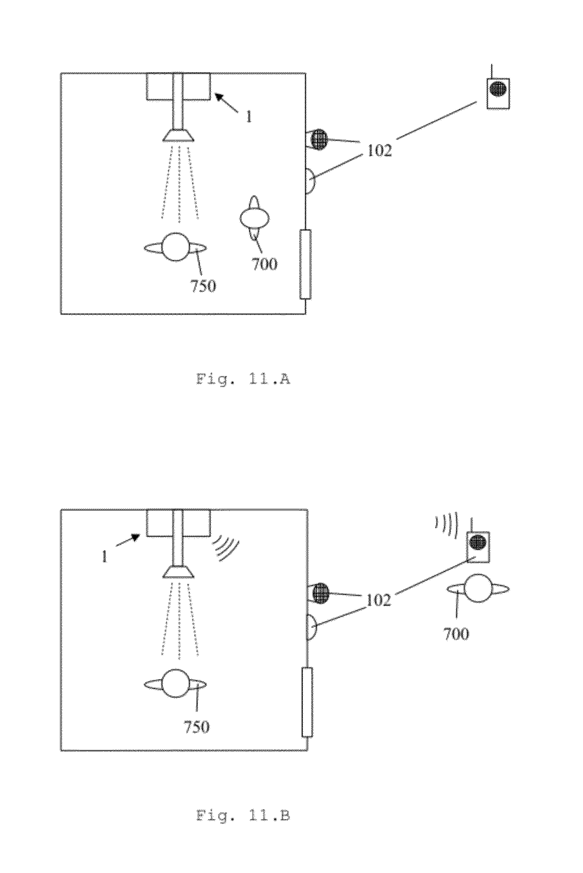

FIGS. 11.A and 11.B show various alerting devices 102, such as a remote speaker, a remote light indicator, and a mobile device. In FIG. 11.A, alarm 1 is detecting high risk person 750 in the shower and detecting person 700 assisting person 750. In FIG. 11.B, all alerting devices are alerting individual 700, after being triggered by alarm 1, to assist the high risk person 750 in the bathing unit. Person 700 might be an adult, a healthcare professional, or a person placed in charge, or even a bystander who happens to be alerted by alarms 102 of the dangerous situation. In FIG. 11.B, the possible high risk situation detected may be that, for example, there is a person in the bathing unit that has been left unattended for too long. Another possible high risk scenario that might trigger the alarm is that the high risk person in the bathing unit is detected, but the second person detecting device, directed to detect someone next to the high risk person 750, does not detect anybody there. Yet another possible high risk scenario could involve alarm 1 in FIG. 11.B having only one person detecting device for detecting high risk person 750, yet detecting only that there is water flowing, possibly meaning that high risk person has slipped or fallen on the floor and is outside of the scope and range of the person detecting device, triggering the alerting devices 102.

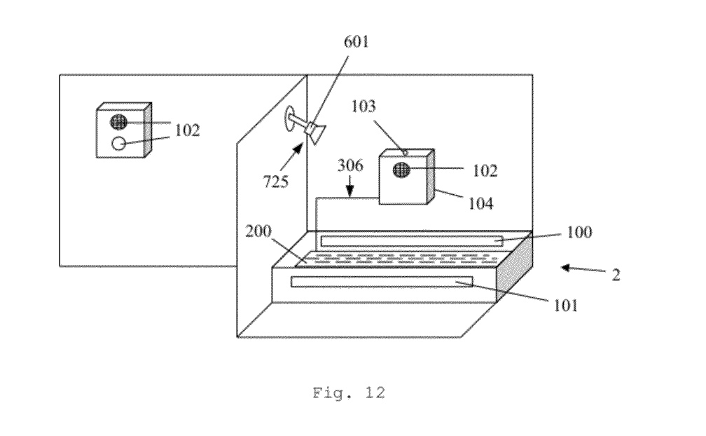

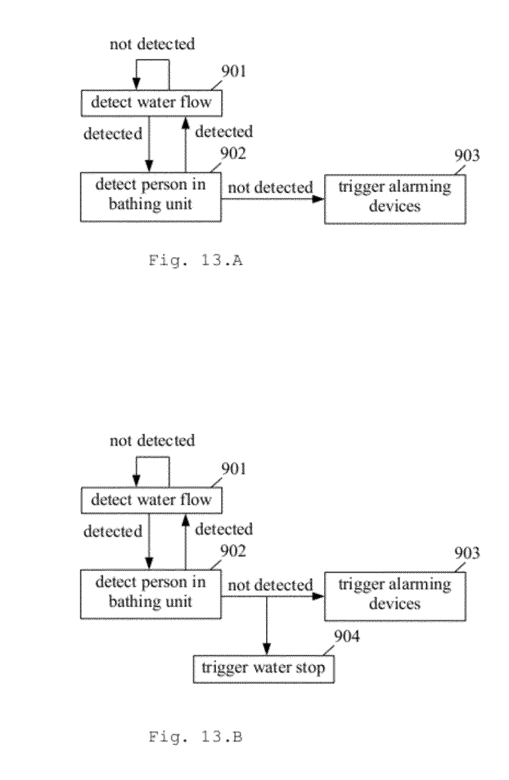

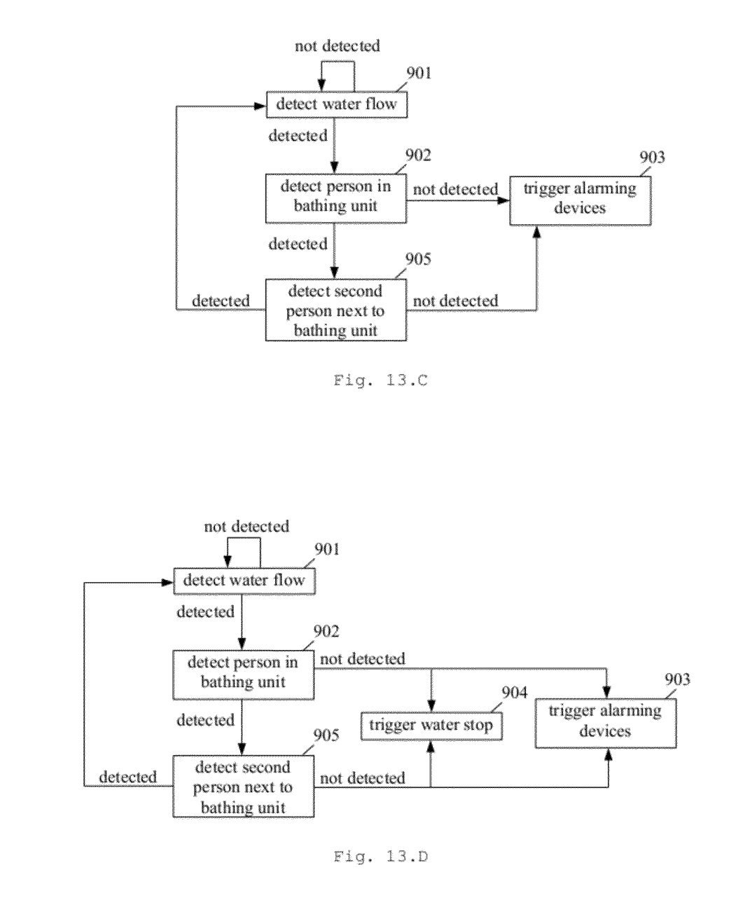

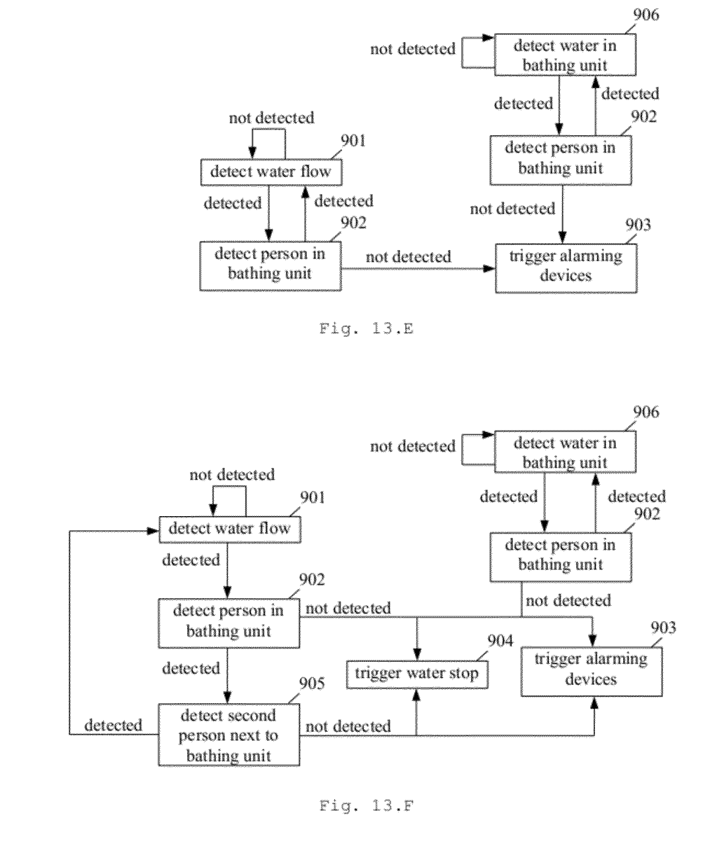

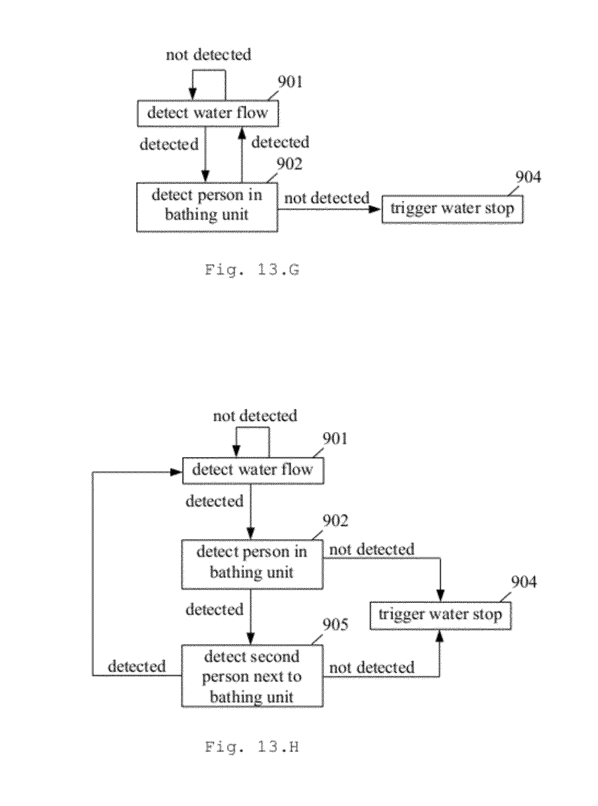

FIG. 12 show the best mode implementation. The main controller 600 and communications system 602 are inside waterproof enclosure 104, protecting the main electronics from water damage. Water flow detector 103 is able to sense if water is coming into bathing unit 2 through shower head 725. In case of detection of a high risk situation, alerting devices 102 are outside of the bathing unit with lights and sound to alert healthcare professionals and inside the bathing unit to let the high risk person know that the alarm is functioning. Alerting devices 102 placed outside, and first person detecting device 100 and second person detecting device 101 operate wirelessly, for ease of placement and orientation, as well as simplifying part replacement. A water detecting device 106 is unseen as it is under water 200, but it detects the water 200 and transmits the detection signal to controller 600 through connection 306. Because water detector 106 is under water, it is simpler to have an electrical or mechanical connection directly to either main controller 600 or communication system 602. Water control device 601 is shown, placed on the shower head 725 to control and stop water flowing into the bathing unit 2 if a high risk situation is detected, after being triggered by control 600 to stop the water flow.

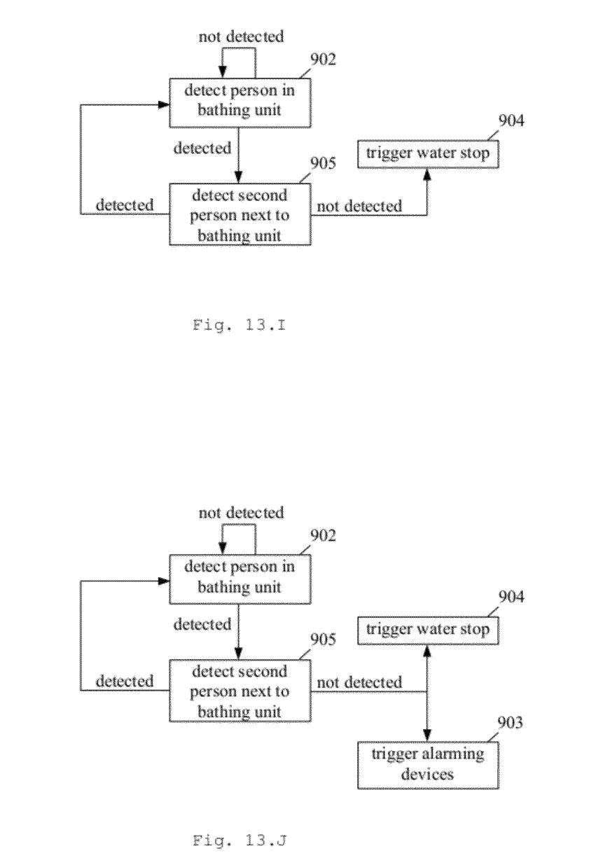

FIG. 13.A shows a simple method to use or program the alarm. First, step 901 checks if there is water running. If the water flow is not detected, the process keeps checking to detect the flow of water in the bathing unit. If a person left without turning on the water, or after turning it off, water flow will not be detected, and the system goes back to step 901 to check if there is water flow. If the water is turned on, then the system loops between or simultaneously checks step 901 and step 902, checking for water flow and if a person is in the bathing unit. If the water flow in never turned off, then the system stays in the steps 901 and 902 loop, except if the person is no longer detected. This may happen if the person slips or falls in the bathing unit, going out of the range and scope of the alarm sensors, such as sensor 100. If this happens, the system goes to step 903, which is triggering the alarms and alerts, such as operating alerting devices 102.

FIG. 13.B shows the same process as in FIG. 13.A, but an additional step 904 for stopping the water is shown and occurs for the same reasons as step 903, as disclosed above.

FIG. 13.C shows a similar process as in FIGS. 13.A and 13.B, but at step 902 for detecting a person in the bathing unit, if the person is detected, then the process checks if a second person that should be next to the bathing unit is detected or not detected as step 905. If the second person is detected, the process loops back to step 901. If the second person is not detected at step 905, the system goes to alert triggering step 903. The second person should be a person such as a healthcare professional.

FIG. 13.D describes a process similar to the process of FIG. 13.C described above, but step 904 for stopping the water is added and shown, step 904 occurring for the same reasons as step 903, as disclosed above for FIG. 13.C.

FIG. 13.E shows the process of FIG. 13.A with a parallel process starting with detecting water in the bathing unit step 906. Once water is detected in the bathing unit, it means that the water floor is wet or has water and that if someone falls, they might have hit their head or might have been hurt, therefore not being able to get up, and may even be drowning under water. This is checked with step 902 to detect person in the bathing unit. Someone who has fallen is out of the scope and range of sensors or is otherwise not detected. If this is the case, the process goes to triggering alarming devices step 903.

FIG. 13.F shows the process of FIG. 13.D with a parallel process starting with detecting water in the bathing unit step 906. Once water is detected in the bathing unit, it means that the water floor is wet or has water and that if someone falls, they might have hit their head or might have been hurt, therefore not being able to get up, and may even be drowning under water. This is checked with step 902 to detect person in the bathing unit. Someone who has fallen is out of the scope and range of sensors or is otherwise not detected. If this is the case, the process goes to triggering alarming devices step 903 and triggering the water stop step 904.

FIG. 13.G starts with step 901, checking if there is water running. If a person left without turning on the water, or after turning it off, water flow will not be detected, and the system goes back to step 901 to check if there is water flow. If the water is turned on, then the system loops between or simultaneously checks step 901 and step 902, checking for water flow and if a person is in the bathing unit, like in FIG. 13.A. If the water flow in never turned off, then the system stays in the steps 901 and 902 loop, except if the person is no longer detected. This may happen if the person slips or falls in the bathing unit, going out of the range and scope of the alarm sensors, such as sensor 100. If this happens, the system goes to step 904, which is triggering the control of water for a stop in water flow into the bathing unit.

FIG. 13.H shows a similar process as in FIGS. 13.G and 13.B, but at step 902 for detecting a person in the bathing unit, if the person is detected, then the process checks if a second person that should be next to the bathing unit is detected or not detected as step 905. If the second person is detected, the process loops back to step 901. If the second person is not detected at step 905, the system goes to stopping the water flow step 904. The second person should be a person such as a healthcare professional.

FIG. 13.I shows a process starting at step 902 for detecting a person in the bathing unit. If the person is not detected, the process keeps checking to detect a person in the bathing unit. If the person is detected, then the process checks if a second person that should be next to the bathing unit is detected or not detected as step 905. If the second person is detected, the process loops back to step 902. If the second person is not detected at step 905, the system goes to stopping the water flow step 904.

FIG. 13.J shows a process starting at step 902 for detecting a person in the bathing unit. It is the same as the process in FIG. 13.I described above, but if the second person is not detected at step 905, the process goes to triggering the alerting devices (such as devices 102) at step 903 and stopping the water flow step 904.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

I claim:

1. An alarm, comprising:
(a) a person detecting device configured to detect the presence of a person inside a bathing unit;
(b) one or more alerting devices operable for alerting the occurrence of high risk situations; and
(c) a controller circuit connected to said person detecting device, and said alerting devices, said controller circuit being responsive to
detection signals from said person detecting device for activating said alerting devices in case that a high risk situation is detected.

2. The alarm of claim 1, further comprising:
(a) a water detecting device
for detecting the presence of water in the bathing unit;
(b) said water detecting device connected to said controller circuit, said controller circuit also being responsive to detection signals from said water detecting device for activating said alerting devices in case that a high risk situation is detected.

3. The alarm of claim 1, further comprising:
(a) a water control system for
controlling the flow and presence of water in the bathing unit;
(b) said water control system connected to said controller circuit, said controller circuit also configured to automatically send control signals to said water control system to control the flow of water into the bathing unit in case that a high risk situation is detected.

4. The alarm of claim 1, in which said alerting devices further comprises:
(a) a speaker for sounding an alarm; and
(b) a light indicator capable of visibly alerting the location where a high risk situation is detected.

5. The alarm of claim 1, further comprising:
(a) a water control system for
controlling the flow and presence of water in the bathing unit;
(b) said water control system connected to said controller circuit, said controller circuit also configured to automatically send control signals to said water control system to control the flow of water into the bathing unit in case that a high risk situation is detected; and
(c) in which said alerting devices further comprises:
a speaker for sounding an alarm; and
a light indicator capable of visibly alerting the location where a high risk situation is detected.

6. The alarm of claim 1, further comprising:
(a) a water detecting device
for detecting the presence of water in the bathing unit; and
(b) a water control system
for controlling the flow and presence of water in the bathing unit;
(c) said water detecting device and said water control system connected to said controller circuit, said controller circuit also being responsive to detection signals from said water detecting device for activating said alerting devices in case that a high risk situation is detected and also configured to automatically send control signals to the water control system to control the flow of water into the bathing unit in case that a high risk situation is detected.

7. The alarm of claim 1, further comprising:
(a) a water detecting device
for detecting the presence of water in the bathing unit;
(b) a water control system
for controlling the flow and presence of water in the bathing unit;
(c) said water detecting device and said water control system connected to said controller circuit, said controller circuit also being responsive to detection signals from said water detecting device for activating said alerting devices in case that a high risk situation is detected and also configured to automatically send control signals to the water control system to control the flow of water into the bathing unit in case that a high risk situation is detected; and
(d) in which said alerting devices further comprises:
a speaker for sounding an alarm; and
a light indicator capable of visibly alerting the location where a high risk situation is detected.

8. An alarm, comprising:
(a) a person detecting device to
detect the presence of a person inside a bathing unit;
(b) one or more alerting devices for alerting the occurrence of high risk situations;
(c) a communication system configured to wirelessly receive detection signals from said person detecting device and to wirelessly send activation signals to said alerting devices; and
(d) a controller circuit connected to said communication system, said controller circuit is configured to
receive said detection signals from said person detecting device and said water detecting device through the communication system and to send said activation signals to said alerting devices through the communication system in case that a high risk situation is detected.

9. The alarm of claim 8, further comprising:
(a) a water detecting device
for detecting the presence of water in the bathing unit;
(b) said communication system also configured to wirelessly receive detection signals from said water detecting device; and
(c) said controller circuit also configured to
receive said detection signals from said water detecting device through the communication system.

10. The alarm of claim 8, further comprising:
(a) a water control system for
controlling the flow and presence of water in the bathing unit;
(b) said communication system also configured to wirelessly send control signals to said water control device; and
(c) said controller circuit also configured to
send said control signals to said water control device through the communication system to automatically control the flow of water into the bathing unit in case that a high risk situation is detected.

11. The alarm of claim 8, in which said alerting devices further comprises:
(a) a speaker for sounding an alarm; and
(b) a light indicator capable of visibly alerting the location where a high risk situation is detected.

12. The alarm of claim 8, further comprising:
(a) a water control system for
controlling the flow and presence of water in the bathing unit;
(b) said communication system also configured to wirelessly send control signals to said water control device;
(c) said controller circuit also configured to
send said control signals to said water control device through the communication system to automatically control the flow of water into the bathing unit in case that a high risk situation is detected; and
(d) in which said alerting devices further comprises:
(a) a speaker for sounding an alarm; and
(b) a light indicator capable of visibly alerting the location where a high risk situation is detected.

13. The alarm of claim 8, further comprising:
(a) a water detecting device
for detecting the presence of water in the bathing unit;
(b) a water control system for
controlling the flow and presence of water in the bathing unit;
(c) said communication system also configured to wirelessly receive detection signals from said water detecting device and to wirelessly send control signals to said water control device; and
(d) said controller circuit also configured to
receive said detection signals from said water detecting device through the communication system and to send said control signals to said water control device through the communication system to automatically control the flow of water into the bathing unit in case that a high risk situation is detected.

14. The alarm of claim 8, further comprising:
(a) a water detecting device
for detecting the presence of water in the bathing unit;
(b) a water control system for
controlling the flow and presence of water in the bathing unit;
(c) said communication system also configured to wirelessly receive detection signals from said water detecting device and to wirelessly send control signals to said water control device; and
(d) said controller circuit also configured to
receive said detection signals from said water detecting device through the communication system and to send said control signals to said water control device through the communication system to automatically control the flow of water into the bathing unit in case that a high risk situation is detected; and
(e) in which said alerting devices further comprises:
a speaker for sounding an alarm; and
a light indicator capable of visibly alerting the location where a high risk situation is detected.

15. The alarm of claim 8, further comprising:
(a) a second person detecting device
configured to detect the presence of a another person next to the bathing unit;
(a) a water detecting device
for detecting the presence of water in the bathing unit;
(b) a water control system for
controlling the flow and presence of water in the bathing unit;
(c) said communication system also configured to wirelessly receive detection signals from said second person detecting device and said water detecting device and to wirelessly send control signals to said water control device; and
(d) said controller circuit also configured to
receive said detection signals from said second person detecting device and said water detecting device through the communication system and to send said control signals to said water control device through the communication system to automatically control the flow of water into the bathing unit in case that a high risk situation is detected;
(e) in which said alerting devices further comprises:
a speaker for sounding an alarm and
a light indicator capable of visibly alerting the location where a high risk situation is detected.

16. An alarm, comprising:
(a) a first person detecting device configured to detect the presence of a person inside a bathing unit;
(b) a second person detecting device
configured to detect the presence of a another person next to the bathing unit;
(c) one or more alerting devices
operable for alerting the occurrence of high risk situations; and
(d) a controller circuit connected to said first person detecting device, said second person detecting device, and said alerting devices, said controller circuit being responsive to
detection signals from said first person detecting device and second person detecting device for activating said alerting devices in case that a high risk situation is detected.

17. The alarm of claim 16, further comprising:
(a) a water detecting device
for detecting the presence of water in the bathing unit;
(b) said water detecting device connected to said controller circuit, said controller circuit also being responsive to detection signals from said water detecting device for activating said alerting devices in case that a high risk situation is detected.

18. The alarm of claim 16, further comprising:
(a) a water control system for
controlling the flow and presence of water in the bathing unit;
(b) said water control system connected to said controller circuit, said controller circuit also configured to automatically send control signals to said water control system to control the flow of water into the bathing unit in case that a high risk situation is detected.

19. The alarm of claim 16, in which said alerting devices further comprises:
(a) a speaker for sounding an alarm; and
(b) a light indicator capable of visibly alerting the location where a high risk situation is detected.

20. The alarm of claim 16, further comprising:
(a) a water control system for
controlling the flow and presence of water in the bathing unit;
(b) said water control system connected to said controller circuit, said controller circuit also configured to automatically send control signals to said water control system to control the flow of water into the bathing unit in case that a high risk situation is detected; and
(c) in which said alerting devices further comprises:
a speaker for sounding an alarm; and
a light indicator capable of visibly alerting the location where a high risk situation is detected.

21. A method of reducing risk to persons in bathing units, the method comprising:
(a) detecting if there is a water flow into the bathing unit;
(b) detecting if a person is in a bathing unit; and
(c) triggering one or more alerting devices to start an alarm if the person in the bathing unit is not detected and the water flow is detected.

22. The method of reducing risk to persons in bathing units of claim 21, the method further comprising:
stopping the water flow into the bathing unit if the person in the bathing unit is not detected and the water flow is detected.

23. The method of reducing risk to persons in bathing units of claim 21, the method further comprising:
(a) detecting if a second person is next to the bathing unit; and
(b) triggering one or more alerting devices to start an alarm if the person in the bathing unit is detected and the second person that should be next to the bathing unit is not detected.

24. The method of reducing risk to persons in bathing units of claim 21, the method further comprising:
(a) detecting if a second person is next to the bathing unit;
(b) triggering one or more alerting devices to start an alarm if the person in the bathing unit is detected and the second person that should be next to the bathing unit is not detected;
(c) stopping the water flow into the bathing unit if the person in the bathing unit is not detected and the water flow is detected; and
(d) stopping the water flow into the bathing unit if the person in the bathing unit is detected and the second person that should be next to the bathing unit is not detected.

25. The method of reducing risk to persons in bathing units of claim 21, the method further comprising:
(a) detecting if there is water in the bathing unit; and
(b) triggering one or more alerting devices to start an alarm if the person in the bathing unit is not detected and water in the bathing unit is detected.

26. The method of reducing risk to persons in bathing units of claim 21, the method further comprising:
(a) detecting if there is water in the bathing unit;
(b) detecting if a second person is next to the bathing unit;
(c) triggering one or more alerting devices to start an alarm if the person in the bathing unit is detected and the second person that should be next to the bathing unit is not detected;
(d) triggering one or more alerting devices to start an alarm if the person in the bathing unit is not detected and water in the bathing unit is detected;
(e) stopping the water flow into the bathing unit if the person in the bathing unit is detected and the second person that should be next to the bathing unit is not detected;
(f) stopping the water flow into the bathing unit if the person in the bathing unit is not detected and the water flow is detected; and
(g) stopping the water flow into the bathing unit if the person in the bathing unit is not detected and water in the bathing unit is detected.

27. A method of reducing risk to persons in bathing units, the method comprising:
(a) detecting if there is a water flow into the bathing unit;
(b) detecting if a person is in a bathing unit; and
(c) stopping the water flow into the bathing unit if the person in the bathing unit is not detected and the water flow is detected.

28. The method of reducing risk to persons in bathing units of claim 27, the method further comprising:
(a) detecting if a second person is next to the bathing unit; and
(b) stopping the water flow into the bathing unit if the person in the bathing unit is detected and the second person that should be next to the bathing unit is not detected.

29. A method of reducing risk to persons in bathing units, the method comprising:
(a) detecting if a person is in a bathing unit;
(b) detecting if a second person is next to the bathing unit; and
(c) triggering one or more alerting devices to start an alarm if the person in the bathing unit is detected and the second person that should be next to the bathing unit is not detected.

30. The method of reducing risk to persons in bathing units of claim 29, the method further comprising:
stopping the water flow into the bathing unit if the person in the bathing unit is detected and the second person that should be next to the bathing unit is not detected.
